(19) United States
(12) Patent Application Publication
(10) Pub. No.: US 2015/0127681 A1
(43) Pub. Date: May 7, 2015

(54) ELECTRONIC DEVICE AND SEARCH AND DISPLAY METHOD OF THE SAME

(71) Applicant: Samsung Electronics Co., Ltd., Gyeonggi-do (KR)

(72) Inventors: Jangwoo LEE, Gyeongsangbuk-do (KR); Songgeun KIM, Gyeongsangbuk-do (KR); Jaeho LEE, Daegu (KR); Hyesoon JEONG, Gyeongsangbuk-do (KR)

(73) Assignee: Samsung Electronics Co., Ltd.

(21) Appl. No.: 14/458,943

(22) Filed: Aug. 13, 2014

(30) Foreign Application Priority Data
Aug. 13, 2013 (KR) 10-2013-0095897

(51) Int. Cl. G06F 17/30; G06F 3/0488

(52) U.S. Cl. CPC G06F 17/30675; G06F 3/0488; G06F 17/30696
USPC 707/772; 715/863

(57) ABSTRACT

A search and display method of an electronic device using handwriting is provided. The search and display method includes recognizing the handwriting, determining whether the recognized handwriting is a gesture or text, recognizing the gesture if it is determined that the recognized handwriting is the gesture, and registering gesture information about the gesture and function information about a function corresponding to the gesture information based on the recognized gesture.

### PRIORITY

This application claims priority under 35 U.S.C. §119(a) to a Korean Patent Application filed on Aug. 13, 2013 in the Korean Intellectual Property Office and assigned Serial No. 10-2013-0095897, the entire content of which is incorporated herein by reference.

### BACKGROUND

1. Field of the Invention

The present invention generally relates to a search and display method using handwriting and an electronic device using the same.

2. Description of the Related Art

The utilization of a touch input for intuitively generating input in various types of mobile devices, such as smart phones and tablet PCs, is gradually increased.

A touch input may be generated through input means, such as the human body (e.g., a finger), a physical tool, and a pen. The demand for a search for intuitive image information or text information through a touch input is recently increasing.

A conventional electronic device is problematic in that file search or Internet search is possible through only input using a text key pad because a touch input is not frequently used.

### SUMMARY

The present invention has been made to address at least the above problems and/or disadvantages and to provide at least the advantages below. Accordingly, an aspect of the present invention is to provide an electronic device and a search and display method of the same, and a method capable of making a search using handwriting.

In accordance with an aspect of the present invention, a search and display method of an electronic device using handwriting is provided. The method includes recognizing the handwriting, determining whether the recognized handwriting is a gesture or text, recognizing the gesture if it is determined that the recognized handwriting is the gesture, and registering gesture information about the gesture and function information about a function corresponding to the gesture information based on the recognized gesture.

In accordance with another aspect of the present invention, an electronic device is provided and includes an input unit configured to recognize handwriting, a control unit configured to determine whether the recognized handwriting is a gesture or text, to recognize the gesture if it is determined that the recognized handwriting is the gesture, and to register gesture information about the gesture and function information about a function corresponding to the gesture information based on the recognized gesture, a storage unit configured to store the gesture information and the function information, and a display unit configured to display a function corresponding to the recognized handwriting.

### BRIEF DESCRIPTION OF THE DRAWINGS

The above and other aspects, features, and advantages of certain embodiments of the present invention will become more apparent from the following detailed description when taken in conjunction with the accompanying drawings in which:

FIG. 1 is a block diagram illustrating a configuration of an electronic device in accordance with an embodiment of the present invention;

FIG. 2 is a block diagram illustrating a configuration of an input unit in accordance with an embodiment of the present invention;

FIG. 3 is a flowchart illustrating a search and display method of the electronic device using handwriting in accordance with an embodiment of the present invention;

FIG. 4 is a flowchart illustrating a search and display method performed by the electronic device in response to a gesture input using handwriting in accordance with an embodiment of the present invention;

FIG. 5 is a flowchart illustrating a method of solving an equation according to a text input using handwriting in accordance with an embodiment of the present invention;

FIG. 6 is a signal flowchart between the electronic device and a server in accordance with an embodiment of the present invention; and

FIGS. 7A-7B, 8 and 9 are diagrams showing a search and display method of the electronic device using handwriting in accordance with an embodiment of the present invention.

### DETAILED DESCRIPTION OF EMBODIMENTS OF THE PRESENT INVENTION

Embodiments of the present invention will now be described in detail with reference to the accompanying drawings to the extent that those skilled in the art may easily implement the technical spirit of the present invention.

Embodiments of the present invention will now be described more fully with reference to the accompanying drawings. However, the embodiments do not limit the present invention to a specific implementation, but should be construed as including all modifications, equivalents, and replacements included within the scope of the present invention, as defined in the appended claims and their equivalents.

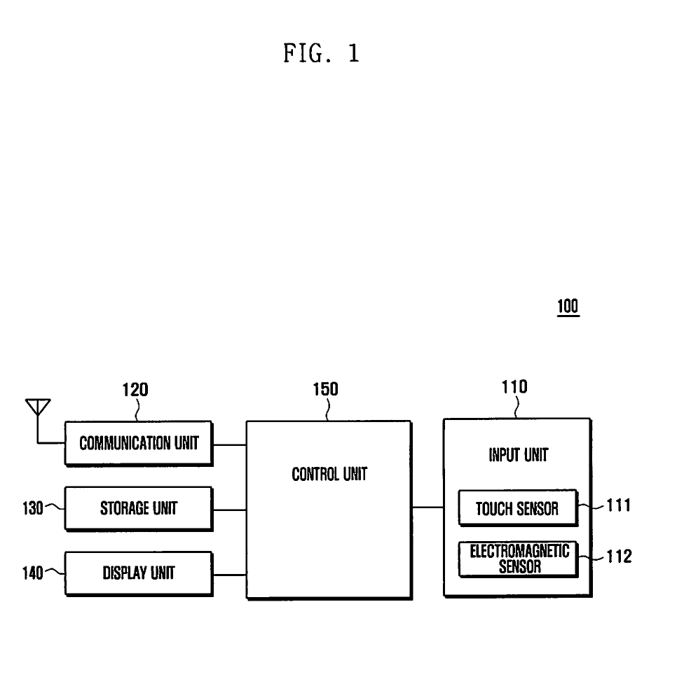

FIG. 1 is a block diagram illustrating a configuration of an electronic device in accordance with an embodiment of the present invention.

The electronic device 100 includes an input unit 110, a communication unit 120, a storage unit 130, a display unit 140, and a control unit 150.

The input unit 110 detects a user's input and transfers an input signal corresponding to the user input to the control unit 150. The input unit 110 may be configured to include a touch sensor 111 and an electromagnetic sensor 112.

The touch sensor 111 detects a user's touch input. For example, the touch sensor 111 may be a touch film, a touch sheet, or a touch pad. The touch sensor 111 detects a touch input and transfers a touch signal, corresponding to the detected touch input, to the control unit 150. When the touch signal is transferred to the control unit 150, the electronic device 100 displays information, corresponding to the touch signal, on the display unit 140. The touch sensor 111 receives a manipulation signal according to a user's touch input through various input means. The touch sensor 111 detects a touch input using a user's human body (e.g., a hand) or a physical tool. The touch sensor 111 detects a proximity input within a specific distance in addition to a direct touch.

The electromagnetic sensor 112 detects a touch or a proximity input in response to a change in the intensity of electromagnetic field. The electromagnetic sensor 112 may be configured to include a coil that induces a magnetic field, and detects the approach of an object including a resonant circuit that changes the energy of a magnetic field generated by the electromagnetic sensor 112. The electromagnetic sensor 112 may be a pen, such as a stylus pen or a digitizer pen that is an object including a resonant circuit. The electromagnetic sensor 112 detects not only a direct input to the electronic device 100, but a proximity input or a hovering input that is performed in proximity to the electronic device 100. Input means for generating input for the electromagnetic sensor 112 may include a key, a button, a dial, etc., and may change the energy of a magnetic field differently depending on the operation of the key, the button, the dial, etc. Accordingly, the electromagnetic sensor 112 detects the operation of a key, a button, a dial, etc. of the input means.

The input unit 110 may be formed as an input pad. The input unit 110 may be configured in such a manner that the touch sensor 111 and the electromagnetic sensor 112 are mounted on the input pad. The input unit 110 may be formed as an input pad on which the touch sensor 111 is attached in a film form or with which the touch sensor 111 is combined in a panel form. Alternatively, the input unit 110 may be formed as an input pad of an ElectroMagnetic Resonance (EMR) or ElectroMagnetic Interference (EMI) method using the electromagnetic sensor 112. The input unit 110 may include one or more input pads that form a mutual layer structure in order to detect input using a plurality of sensors.

The input unit 110 may be formed as a layer structure along with the display unit 140, and may operate as an input screen. For example, the input unit 110 may be formed as a Touch Screen Panel (TSP) configured to include an input pad equipped with the touch sensor 111 and combined with the display unit 140. The input unit 110 may be configured to include an input pad equipped with the electromagnetic sensor 112, and may be combined with the display unit 140 formed as a display panel.

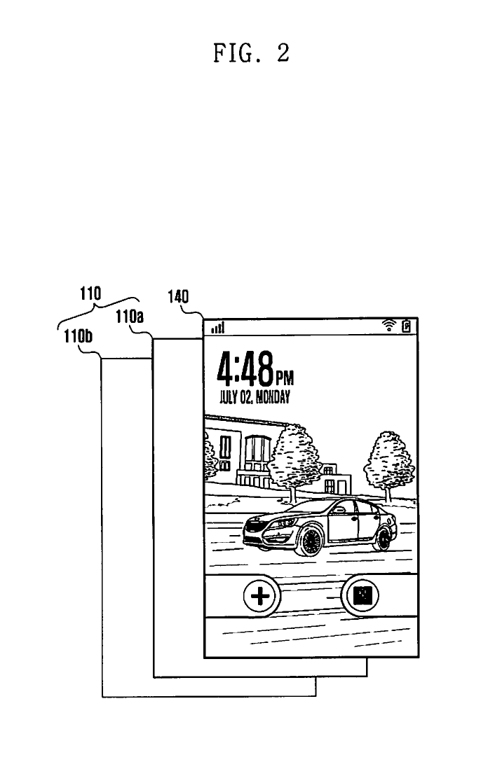

FIG. 2 is a block diagram illustrating a configuration of the input unit 110 in accordance with an embodiment of the present invention.

The input unit 110 may be configured to include a first input pad 110a and a second input pad 110b that form a mutual layer structure. The first input pad 110a and the second input pad 110b may be the touch sensor 111, a touch pad including a pressure sensor 112, a pressure pad, an electromagnetic pad including the electromagnetic sensor 112, or an EMR pad. The first input pad 110a and the second input pad 110b correspond to different types of input means and detect inputs generated by different input means. For example, the first input pad 110a may be a touch pad, and may detect a touch input by the human body. The second input pad 110b may be an EMR pad, and may detect an input by a pen. The input unit 110 may detect multipoint inputs generated in the first input pad 110a and the second input pad 110b. In this case, an input pad configured to detect the input of a pen may detect the operation of a key, a button, a jog dial, etc. included in the pen.

Furthermore, the input unit 110 may be configured as a layer structure along with the display unit 140. The first input pad 110a and the second input pad 110b are placed at the lower layer of the display unit 140. Inputs generated through an icon, a menu, a button, etc. displayed on the display unit 140 are detected by the first input pad 110a and the second input pad 110b. In general, the display unit 140 may have a display panel form, and may be formed as a TSP panel combined with an input pad.

The combined construction of the input unit 110 and the display unit 140 shown in FIG. 2 is shown as an example, and the type and the number of input pads forming the input unit 110 and the location of upper and lower layers of the input pad and the display unit 140 may be changed in various ways depending on a technique for manufacturing the electronic device 100.

Referring back to FIG. 1, the input unit 110 detects a touch input. A touch input in accordance with an embodiment of the present invention may be a hovering input. The input unit 110 generates an input signal corresponding to a touch input and transfers the input signal to the control unit 150. The input unit 110 may generate an input signal, including information about a touch input, based on the location where the touch input is generated, an input means, and the manipulation state of a button, etc. included in the input means.

The communication unit 120 supports the wireless communication function of the electronic device 100, and may include a mobile communication module if the electronic device supports a mobile communication function. The communication unit 120 may include a Radio Frequency (RF) transmitter configured to perform up-conversion and amplification on the frequency of a transmitted radio signal and an RF receiver configured to perform low-noise amplification on a received radio signal and to perform down-conversion on the frequency of the radio signal. Furthermore, if the electronic device 100 supports short-range wireless communication functions, such as Wi-Fi communication, Bluetooth communication, Zigbee communication, Ultra WideBand (UWB) communication, and Near Field Communication (NFC) communication, the communication unit 120 may include a Wi-Fi communication module, a Bluetooth communication module, a Zigbee communication module, a UWB communication module, and an NFC communication module. The communication unit 120 in accordance with an embodiment of the present invention sends and receives information including text, image information, equation information, or the solution results of equation information to and from a specific server or another electronic device.

The storage unit 130 stores programs or instructions for the electronic device 100. The control unit 150 executes the programs or instructions stored in the storage unit 130. The storage unit 130 may include one or more types of storage media, including a flash memory type, a hard disk type, a multimedia card micro type, card type memory (e.g., Secure Digital (SD) or xD memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, a magnetic disk, and an optical disk.

The storage unit 130 stores a user input and information about an operation corresponding to the location of the input. The storage unit 130 stores information about a gesture that is generated in response to handwriting and that enables the control unit 150 to recognize the handwriting or text information generated in response to handwriting. The control unit 150 recognizes handwriting and determines whether recognized handwriting is a gesture or text. For example, the gesture may be drawing or non-text. If handwriting is recognized as a gesture, the control unit 150 may store information about the gesture and a function corresponding to the gesture in the storage unit 130. The gesture information may include information about at least one of the strokes of the gesture and information about at least one of the shapes of the gesture. The stroke information is information about a stroke of the gesture, and the shape information is information about a shape of the gesture that is formed by a group of strokes. The control unit 150 converts the gesture information into a unicode or timestamp form, and stores the converted gesture information in the storage unit 130. The control unit 150 determines the attributes of the handwriting based on the gesture information and the text information stored in the storage unit 130.

The display unit 140 displays (or outputs) information processed in the electronic device 100. For example, the display unit 140 displays guide information, corresponding to an application, a program, or service now being driven, along with a User Interface (UI) or a Graphic User Interface (GUI).

The display unit 140 may include at least one of a Liquid Crystal Display (LCD), a Thin Film Transistor LCD (TFT LCD), an Organic Light-Emitting Diode (OLED), a flexible display, and a three-dimensional (3D) display.

The display unit 140 may be formed as a mutual layer structure along with the touch sensor 111 and/or the electromagnetic sensor 112 that form the input unit 110 and may operate as a touch screen. The display unit 140 operating as a touch screen may function as an input device.

The display unit 140 displays document information stored in the storage unit 130 under the control of the control unit 150. The display unit 140 may highlight and display at least one of text and an image in response to a detected gesture, may display the search results of at least one of the text and the image in response to a detected gesture, or may display the search results of tags included in at least one of the text and the image in response to a detected gesture, under the control of the control unit 150.

The control unit 150 controls the elements for the overall operation of the electronic device 100. The control unit 150 recognizes handwriting detected by the input unit 110. The control unit 150 determines whether recognized handwriting is a gesture or text, and registers information about the gesture and information about a function corresponding to the gesture information if it is determined that the recognized handwriting is the gesture. In this case, the gesture information and the function corresponding to the gesture information may be selected by a user. The control unit 150 databases the registered gesture information and the information about the function corresponding to the gesture information, and stores them in the storage unit 130. The control unit 150 stores the gesture information and the information about the function corresponding to the gesture information in the storage unit 130. For example, gesture information may include information about at least one of the strokes of a gesture and information about at least one of the shapes of the gesture. Stroke information is information about a stroke of a gesture, and shape information is information about a shape of a gesture formed by a group of strokes. The control unit 150 converts gesture information into a unicode or timestamp form and stores the converted information in the storage unit 130. For example, information about a function corresponding to gesture information relates to a function generated when a gesture input is detected, and the information may include the highlight display of at least one of text, content, and an image, the display of the search results of at least one of the text, the content, and the image, and the display of the search results of tags included in at least one of the text, the content, and the image.

When a gesture input is detected by the input unit 110, the control unit 150 searches for gesture information stored in the storage unit 130 and recognizes the gesture input. The control unit 150 executes a function, corresponding to gesture information, in response to a recognized gesture input. If recognized handwriting is determined to be a text, the control unit 150 recognizes the text generated by the handwriting based on text information stored in the storage unit 130, performs a search function based on the recognized text, and displays the results of the search. If the recognized text is an equation (i.e., a mathematical equation), the control unit 150 may solve the equation and display the results of the solution on the display unit 140. In accordance with another embodiment, if the recognized text is an equation (i.e., a mathematical equation), the control unit 150 may convert the equation in a specific format (e.g., an equation format) and may send the specific format to a specific server through the communication unit 120.

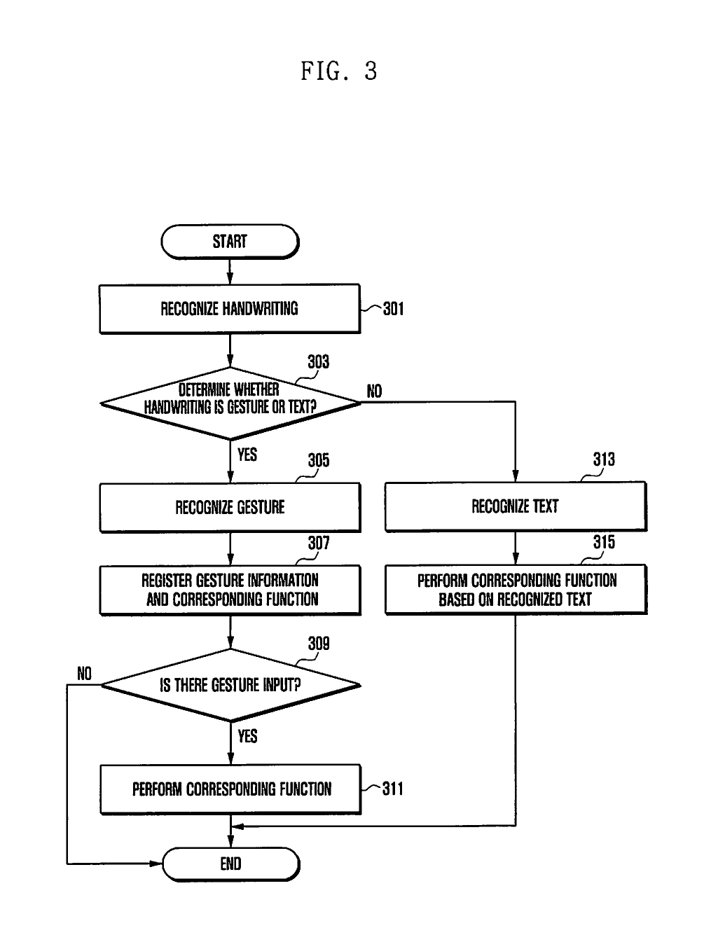

FIG. 3 is a flowchart illustrating a search and display method of the electronic device using handwriting in accordance with an embodiment of the present invention.

The electronic device 100 recognizes handwriting detected by the input unit 110 in step 301. In step 303, the electronic device 100 determines whether the recognized handwriting is a gesture or text. If, as a result of the determination, the recognized handwriting is a gesture, the electronic device 100 recognizes the gesture using a recognition engine in step 305. In step 307, the electronic device 100 registers information about the gesture and information about a function corresponding to the gesture information based on the recognized gesture. In this case, the gesture information may include information about at least one of the strokes of the gesture and information about at least one of the shapes of the gesture. The stroke information is information about a stroke of the gesture, and the shape information is information about a shape of the gesture formed by a group of strokes. The electronic device 100 converts the gesture information into a unicode or timestamp form and stores the converted gesture information. The function information corresponding to the gesture information relates to a predetermined function that is executed when a gesture is recognized, and may include the highlight display of at least one of text, content, and an image, the display of the search results of at least one of the text, the content, and the image, and the display of the search results of tags included in at least one of the text, the content, and the image. The electronic device 100 may detect a gesture input through the input unit 110 in step 309, even when an application, such as a photo application, a schedule application, a memo application, a map application, or an Internet browser application, is executed. Here, the gesture input is same as the recognized gesture from the handwriting.

The electronic device 100 performs a corresponding function which is predetermined to be executed in response to the detected gesture input in step 311. In this case, the corresponding function may include the highlight display of at least one of text, content, and an image, the display of the search results of at least one of the text, the content, and the image, the display of the search results of tags included in at least one of the text, the content, and the image, and an operation of magnifying and displaying a map if the content is the map or displaying information (e.g., a road or address corresponding to adjacent coordinates) included in the map. The electronic device 100 recognizes the text using the recognition engine in step 313, even when, as a result of the determination, the recognized handwriting is a text, and when an application, such as a photo application, a schedule application, a memo application, a map application, or an Internet browser application, is executed. In step 315, the electronic device 100 may perform a corresponding function which is predetermined to be executed in response to the recognized text or make a search based on the recognized text.

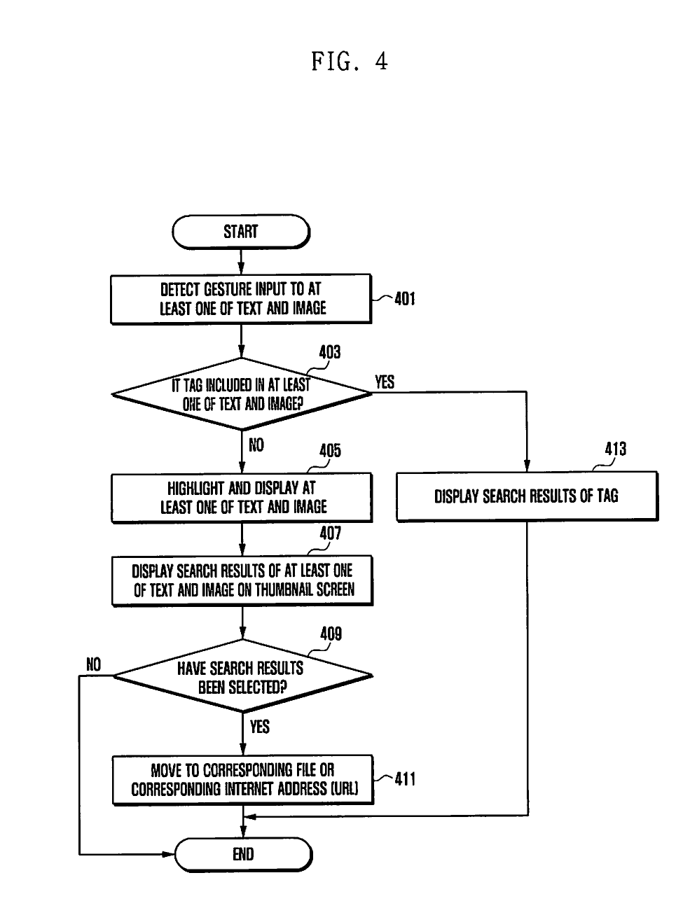

FIG. 4 is a flowchart illustrating a search and display method performed by the electronic device in response to a gesture input using handwriting in accordance with an embodiment of the present invention. Hereinafter, an input through handwriting that is recognized as a gesture refers to a gesture input.

The electronic device 100 detects a gesture input in a position displaying at least one of text information and image information on a display unit in step 401, even when an application, such as a photo application, a schedule application, a memo application, a map application, or an Internet browser application, is executed. In step 403, the electronic device 100 determines whether tag information is included in at least one of the text information and the image information. If it is determined that tag information is not included in at least one of the text information and the image information, the electronic device 100 highlights and displays (e.g., highlights and changes of color) at least one of the text information and the image information in step 405. In step 407, the electronic device 100 displays search results of at least one of the text information and the image information on a thumbnail screen. For example, the thumbnail screen may be a pop-up widow. The electronic device 100 determines whether search results have been selected in step 409. When it is determined that the search results are selected, the electronic device 100 displays a selected file or a selected Internet address (e.g., a URL) in step 411. If, as a result of the determination in step 403, it is determined that tag information is included in at least one of the text information and the image information, the electronic device 100 displays search results of the tag information.

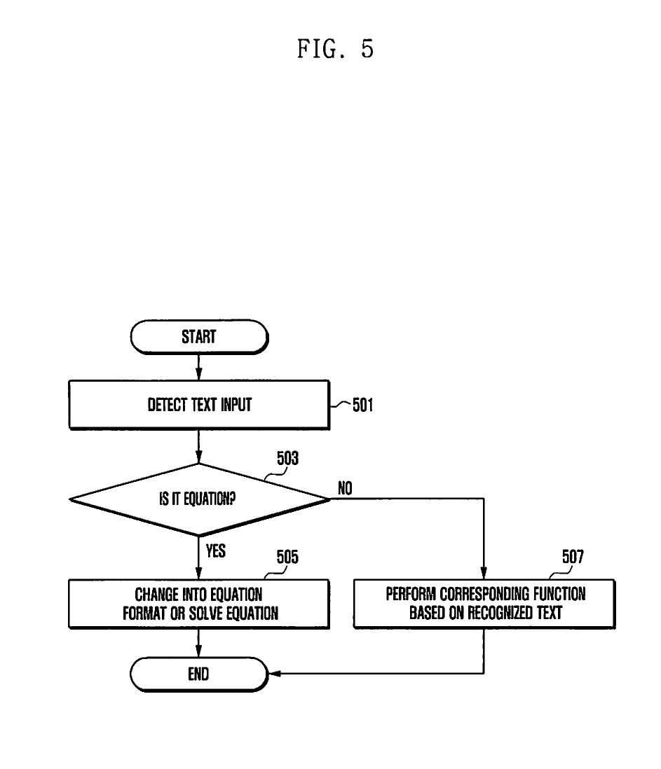

FIG. 5 is a flowchart illustrating a method of solving an equation according to a text input using handwriting in accordance with an embodiment of the present invention. Hereinafter, an input through handwriting that is recognized as a text refers to a text input.

The electronic device 100 detects a text input and recognizes the text using the recognition engine in step 501, even when an application, such as a photo application, a schedule application, a memo application, a map application, or an Internet browser application, is executed. In step 503, the electronic device 100 determines whether the recognized text is an equation. If it is determined that the recognized text is an equation, the electronic device 100 changes an equation into a specific format (e.g., an equation format) or solves the recognized equation in step 505. If, it is determined that the recognized text is not an equation, the electronic device 100 performs a corresponding function that is predetermined to be executed in response to the recognized text or make a search based on the recognized text in step 507.

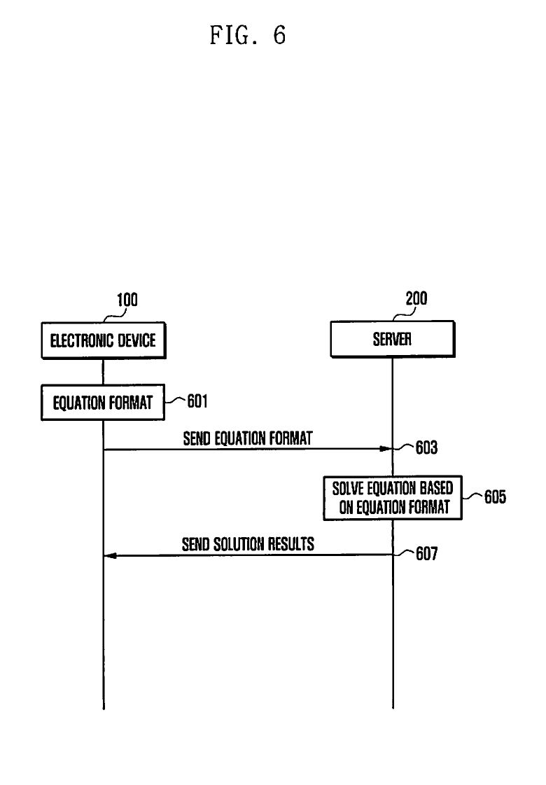

FIG. 6 is a signal flowchart between the electronic device 100 and a server 200 in accordance with an embodiment of the present invention.

If recognized handwriting is recognized as a text, the electronic device 100 determines whether the recognized text is an equation and changes the equation into a specific format (e.g., an equation format) in step 601. The electronic device 100 sends the specific format (e.g., an equation format) to the server 200 in step 603. The server 200 performs calculation to solve the equation based on the specific format (e.g., an equation format) in step 605. The server 200 sends the calculation or solution results to the electronic device 100 in step 607.

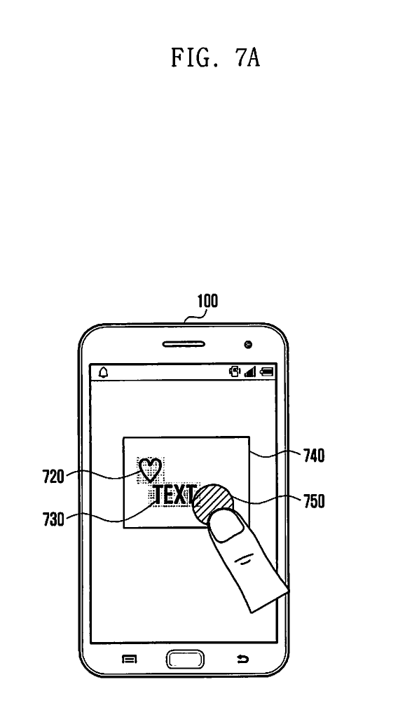

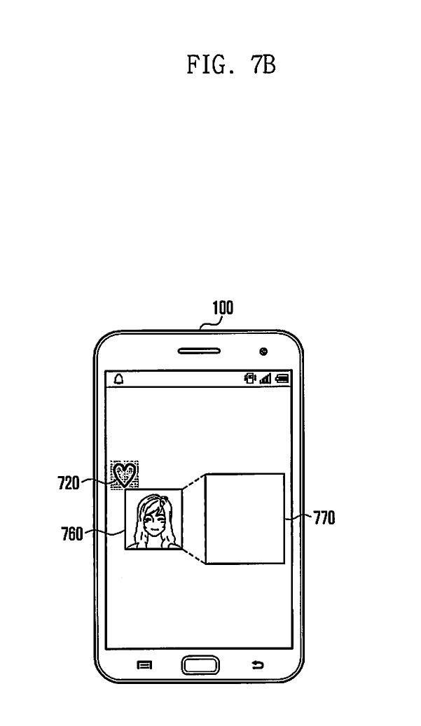

FIGS. 7A-7B, 8 and 9 are diagrams showing a search and display method of the electronic device using handwriting in accordance with an embodiment of the present invention.

FIG. 7A is a diagram showing a method of searching for and displaying text information or image information in response to a gesture input in accordance with an embodiment of the present invention. Hereinafter, an input through handwriting that is recognized as a gesture refers to a gesture input.

When a gesture input 720 is detected in a position displaying text information 730 on the display unit, the electronic device 100 highlights and displays the text information 730. For example, the highlight and display may be a highlighted display or a change of color. In this case, the electronic device 100 highlights and displays at least one of the text information 730 and the gesture input 720. Furthermore, the electronic device 100 may display the search results of the text information 730 on a thumbnail screen 740. When the search results 750 are selected, the electronic device 100 may display a selected file or a selected Internet address (e.g., a URL).

FIG. 7B is a diagram showing a method of searching for and displaying text information or image information in response to a gesture input in accordance with an embodiment of the present invention.

When a gesture input 720 is detected in a position displaying image information 760 including tag information on the display unit, the electronic device 100 displays the search results 770 of the tag information.

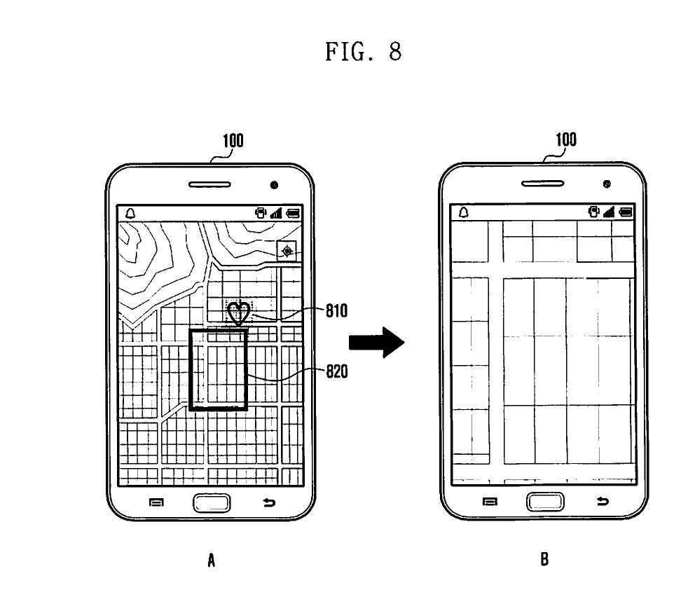

FIG. 8 is a diagram showing a method of searching for and displaying a map in response to a gesture input in accordance with an embodiment of the present invention.

When a gesture input 810 to a specific part on a map 820 is detected when an application including the map 820 has been executed in a screen A, the electronic device 100 magnifies and displays the map around the detected gesture input or displays information (e.g., a road or address corresponding to adjacent coordinates) included in the map as in a screen B.

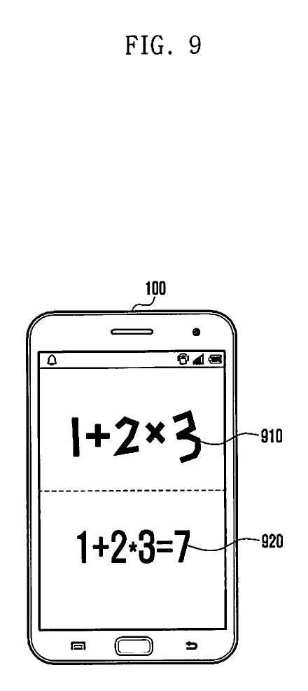

FIG. 9 is a diagram showing solving an equation according to a recognized text in accordance with an embodiment of the present invention.

The electronic device 100 recognizes a text 910 input by handwriting, and changes the recognized text into a text 920 with a font (e.g., typography) stored in the storage unit 130. In this case, if the text 910 is an equation, the electronic device 100 recognizes the equation and displays the solution of the equation 920.

In accordance with the electronic device and the search and display method of the same according to an embodiment of the present invention, a user can check search results through a gesture input using handwriting rapidly and easily.

As described above, those skilled in the art to which the present invention pertains will understand that the present invention may be implemented in various detailed forms without changing the technical spirit or indispensable characteristics of the present invention. It will be understood that the aforementioned embodiments are illustrative and not limitative from all aspects. The scope of the present invention is defined by the appended claims rather than the detailed description, and the present invention should be construed as covering all modifications or variations derived from the meaning and scope of the appended claims and their equivalents.

What is claimed is:

1. A search and display method of an electronic device using handwriting, comprising:
recognizing the handwriting;
determining whether the recognized handwriting is a gesture or text;
recognizing the gesture if it is determined that the recognized handwriting is the gesture; and
registering gesture information about the gesture and function information about a function corresponding to the gesture information based on the recognized gesture.

2. The search and display method of claim 1, further comprising:
recognizing the text if it is determined that the recognized handwriting is the text; and
performing a corresponding function that is predetermined to be executed in response to the recognized text or making a search based on the recognized text.

3. The search and display method of claim 1, further comprising:
detecting a gesture input when an application is executed; and
performing a corresponding function in response to the detected gesture input,
wherein the gesture input refers to an input using handwriting that is recognized as a gesture.

4. The search and display method of claim 3, wherein performing the corresponding function in response to the detected gesture input comprises:
detecting the gesture input in a position displaying at least one of text information and image information on a display unit;
determining whether tag information is included in the at least one of the text information and the image information; and
searching for the tag information if it is determined that the tag information is included in the at least one of the text information and the image information.

5. The search and display method of claim 4, wherein performing the corresponding function in response to the detected gesture input further comprises highlighting and displaying the at least one of the text information and the image information if it is determined that the tag information is not included in the at least one of the text information and the image information.

6. The search and display method of claim 5, wherein performing the corresponding function in response to the detected gesture input further comprises:
displaying search results of the at least one of the text information and the image information on a thumbnail screen if it is determined that the tag information is not included in the at least one of the text information and the image information; and
displaying a selected file or a selected Internet address when the search results are selected.

7. The search and display method of claim 2, wherein performing the corresponding function that is predetermined to be executed in response to the recognized text or making the search based on the recognized text comprises:
determining whether the recognized text is an equation; and
changing the equation into an equation format or solving the equation if it is determined that the recognized text is the equation.

8. The search and display method of claim 1, wherein the gesture information comprises information about at least one of strokes of the recognized gesture or information about at least one of shapes of the recognized gesture.

9. The search and display method of claim 2, wherein the function information about the function corresponding to the gesture information comprises at least one of information about a highlight and display of at least one of a text, content, and an image, information about a display of search results of at least one of the text, the content, and the image, information about a display of search results of tags included in at least one of the text, the content, and the image, and information for magnifying and displaying a map or for displaying information included in the map if the content is the map.

10. The search and display method of claim 9, further comprising converting the gesture information into a unicode or timestamp form and storing the converted information.

11. An electronic device, comprising:
an input unit configured to recognize handwriting;
a control unit configured to determine whether the recognized handwriting is a gesture or text, to recognize the gesture if it is determined that the recognized handwriting is the gesture, and to register gesture information about the gesture and function information about a function corresponding to the gesture information based on the recognized gesture;
a storage unit configured to store the gesture information and the function information; and
a display unit configured to display a function corresponding to the recognized handwriting.

12. The electronic device of claim 11, wherein the control unit is configured to recognize the text if it is determined that the recognized handwriting is the text, and to perform a corresponding function that is predetermined to be executed in response to the recognized text or makes a search based on the recognized text.

13. The electronic device of claim 11, wherein the control unit is configured to detect a gesture input when an application is executed, and to perform a corresponding function in response to the detected gesture input,
wherein the gesture input refers to an input using handwriting that is recognized as a gesture.

14. The electronic device of claim 13, wherein the control unit is configured to detect the gesture input in a position displaying at least one of text information and image information on the display unit, to determine whether tag information is included in the at least one of the text information and the image information, and to search for the tag information if it is determined that the tag information is included in the at least one of the text information and the image information.

15. The electronic device of claim 14, wherein the control unit is configured to highlight and display the at least one of the text information and the image information if it is determined that the tag information is not included in the at least one of the text information and the image information.

16. The electronic device of claim 15, wherein the control unit is configured to display search results of the at least one of the text information and the image information on a thumbnail screen if it is determined that the tag information is not included in the at least one of the text information and the image information, and to display a selected file or a selected Internet address when the search results are selected.

17. The electronic device of claim 12, wherein the control unit is configured to determine whether the recognized text is an equation, and to change the equation into an equation format or solve the equation if it is determined that the recognized text is the equation.

18. The electronic device of claim 11, wherein the gesture information comprises information about at least one of strokes of the recognized gesture or information about at least one of shapes of the recognized gesture.

19. The electronic device of claim 12, wherein the function information about the function corresponding to the gesture information comprises at least one of information about a highlight and display of at least one of a text, content, and an image, information about a display of search results of at least one of the text, the content, and the image, information about a display of search results of tags included in at least one of the text, the content, and the image, and information for magnifying and displaying a map or for displaying information included in the map if the content is the map.

20. The electronic device of claim 12, wherein the control unit is configured to convert the gesture information into a unicode or timestamp form and to store the converted information.
